(19) United States
(12) Patent Application Publication
(10) Pub. No.: US 2025/0039004 A1
(43) Pub. Date: Jan. 30, 2025

(54) Advanced AI and Blockchain-Driven Social Digital Platform for Communication and Educational Management

(71) Applicant: SeyedmohammadMehdi Razavi, Alanya (TR)

(72) Inventor: SeyedmohammadMehdi Razavi, Alanya (TR)

(73) Assignee: Seyed mohammadMehdi Razavi, Alanya, AN (TR)

(21) Appl. No.: 18/778,939

(22) Filed: Jul. 20, 2024

(30) Foreign Application Priority Data
Jul. 27, 2023 (TR) TR2023/008898

(51) Int. Cl. H04L 9/00; G06N 3/0455; G06N 3/0475

(52) U.S. Cl. CPC H04L 9/50; G06N 3/0455; G06N 3/0475

(57) ABSTRACT

The present invention provides a communication management system comprising a processor and a non-transitory computer-readable medium with executable instructions. The system securely stores educational content on a blockchain, performs machine translation, generates formatted documents, creates multimedia using GANs, and develops assessments using NLP. It also evaluates content quality via machine learning, issues digital certificates, offers personalized recommendations, facilitates secure transactions, and supports interactive learning experiences through a collaborative interface. The system is accessible across multiple devices and includes a data collector module for extracting and transmitting metadata.

### CROSS-REFERENCE TO RELATED DISCLOSURE

This disclosure is a continuation-in-part of TR patent application, TR 2023/008898B, entitled “KİŞİSEL, EĞİTİM, MAĞAZA VE İŞLETME İçERİKLİ İLETİŞİM YÖNETİM SİSTEMİ”, filed on Jul. 27, 2023 which is incorporated herein by reference in its entirety.

### TECHNICAL FIELD

The present invention relates to the field of communication and educational management systems. More particularly, but not exclusively, the present invention pertains to a multifunctional social digital platform designed to manage and facilitate personal, educational, and business content.

### BACKGROUND

The current landscape of education and communication is rapidly evolving with technological advancements. Traditional educational systems often struggle to keep pace with the fast-moving advancements in science and technology, leading to a gap in access to high-quality education and expert knowledge.

This gap is further exacerbated by geographical and financial barriers, which limit access to diverse educational resources and hinder students' ability to learn updated information. The rise of social media has also shifted focus away from educational engagement, leading to increased time spent on non-educational activities.

Conventional systems face challenges in ensuring the accuracy of translations, generating visually appealing and contextually relevant educational content, and providing personalized learning experiences. Maintaining the security and integrity of educational content, especially in a collaborative and distributed environment, poses significant challenges.

Moreover, the current educational environment is often one-sided, favoring educational centers and governments, and neglecting the needs of individuals. This has resulted in a selective educational environment, where those who are interested in learning are often deprived of high-quality educational content and environments due to reasons such as lack of capacity, social and political restrictions, financial problems, and language barriers.

Furthermore, students often lack access to their preferred educational resources, and once they enter the workforce, they may not have opportunities to update their knowledge or skills. This highlights the need for a system that can simulate a personalized educational environment, tailored to the needs and interests of each individual, rather than providing concentrated content.

The integration of machine learning and blockchain technologies offers promising solutions to these challenges. Machine translation systems, such as those based on neural network architectures like transformers, have shown great potential in improving translation accuracy. Generative adversarial networks (GANs) can create new images and videos, enhancing the visual appeal and engagement of educational content. Natural language processing (NLP) techniques can be employed to generate assessments and evaluate the quality of educational content, ensuring it meets high standards of relevance and accuracy.

Blockchain technology provides a secure and tamper-proof method for storing and managing educational content, ensuring data integrity and transparency.

By integrating these advanced technologies, the present invention aims to create a comprehensive communication management system that addresses the needs of modern educational environments, providing secure, accurate, and personalized educational experiences.

### BRIEF SUMMARY OF THE INVENTION

The various embodiments herein provide a communication management system that leverages advanced artificial intelligence and blockchain technology. The system may include at least one processor and a non-transitory computer-readable medium configured to store and execute instructions. In the preferred embodiment, the executable instructions may cause the system to store a plurality of educational content items provided by users and content providers in a secure repository on a blockchain. The system may integrate various machine learning methods within a single AI module, which may operate over the network. The system may further include a data collector module that extracts metadata and transmits this data to the blockchain repository. The system may issue digital certificates to users upon completion of all the educational content items in a course, utilizing a certificate issuance module over the network. A personalized recommendation module may be provided through a recommendation engine, which may base its suggestions on the plurality of stored content items in the blockchain repository.

In addition, the system may perform machine translation on the stored educational content using a neural network-based translation model. This model, based on transformer architecture and trained on a large multilingual corpus, ensures high translation accuracy. The translation process is executed on a server-side over the network, facilitating language conversion for educational materials.

Furthermore, the system may generate printable pamphlets from the stored content by executing a document generation algorithm. This algorithm uses predefined templates and layout rules to produce formatted documents. The document generation process is implemented on the server side, ensuring efficient and consistent production of educational materials.

The system may also generate new images and videos based on the stored content items using a generative adversarial network (GAN). The GAN is pre-trained on a dataset of educational multimedia content to create contextually relevant visuals. This multimedia generation is processed on a cloud infrastructure, providing scalable and efficient media production.

The system may create assessments by utilizing natural language processing (NLP) techniques. By performing semantic analysis and concept extraction, the module generates question and answer sets. These assessments are evaluated and refined by a machine learning model to ensure accuracy and relevance.

To maintain high content quality, the system may employ a machine learning-based evaluation framework. This framework extracts various features from the educational content, such as semantic meaning, readability metrics, engagement metrics, relevance, accuracy, completeness, consistency, and tone. It assigns evaluation scores for these features and calculates a weighted sum to generate a quality score. The quality scores are normalized across different content items to create an AI-driven quality score.

Additionally, the system facilitates secure e-commerce transactions through an integrated payment gateway. This gateway supports multiple payment methods, ensuring secure and efficient handling of user transactions. Users may access selected educational content upon successful payment, with the system tracking payment history and content access. The payment gateway module may also incorporate with a notification module that informs users of transactions statuses and content access.

The system may provide an interactive learning experience via a collaborative learning interface. This interface may support real-time communication between users and content providers, featuring a chat room with machine translation for multilingual interactions. The chat room may be configured as private or public, supports multimedia communication, and employs encryption techniques to ensure secure communication.

The collaborative learning interface may also include features for organizing and managing learning activities. Users may create virtual educational pages and personal pages, track their learning progress, and receive updates and notifications. The interface may support the creation of virtual institutes and learning environments, allowing content providers to collaborate and users to participate in customized educational experiences.

Additionally, the system's certificate issuance module may integrate with a digital signature system to provide verifiable and tamper-proof certificates using public-key cryptography. These certificates may be stored on the blockchain for secure verification, ensuring the authenticity and integrity of the issued certificates.

### DETAILED DESCRIPTION OF THE DRAWING

The present invention is best understood by reference to the following description and the accompanying figures. These figures are given purely by way of indication and in no way restrict the scope of the application. Of these figures:

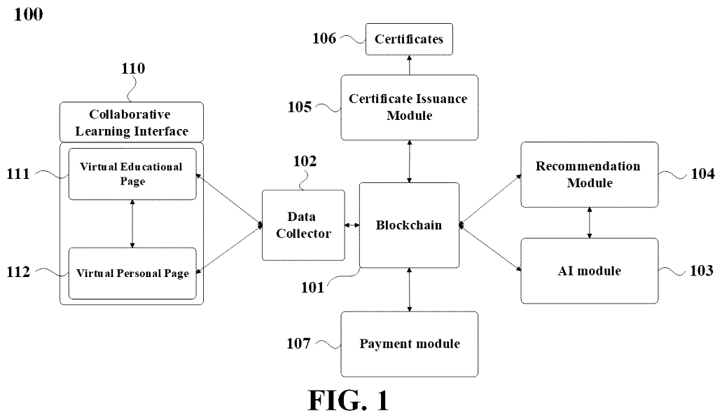

FIG. 1 illustrates a schematic diagram of a communication and educational management system.

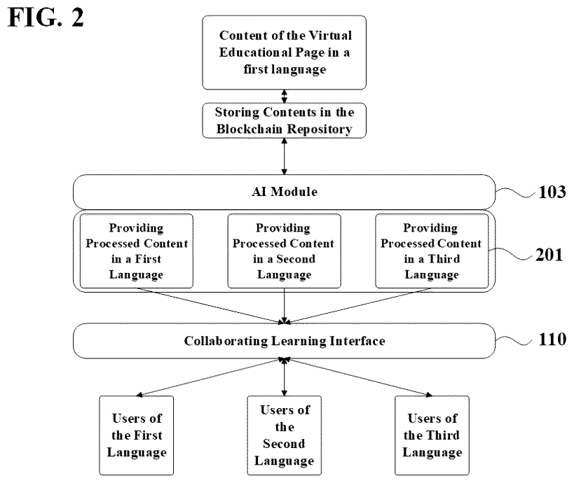

FIG. 2 illustrates a block diagram showing an example of the operation of the system of FIG. 1, including the role of the AI module, according to one embodiment herein.

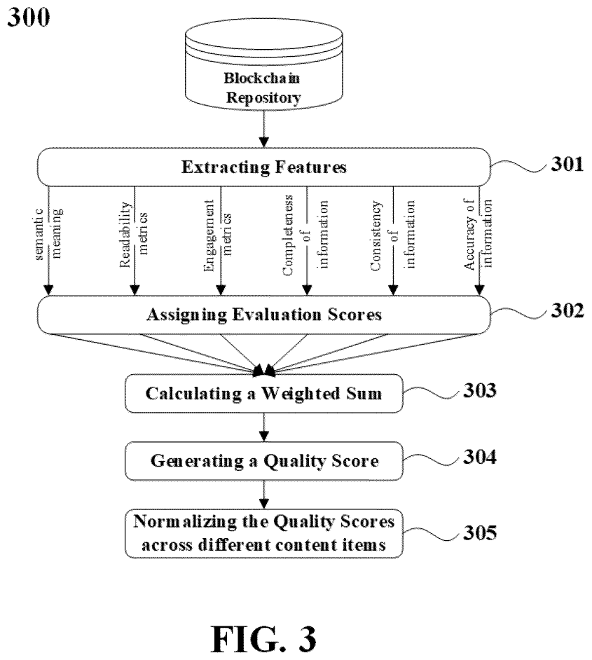

FIG. 3 illustrates a flowchart diagram depicting the recommendation methodology, according to one embodiment herein.

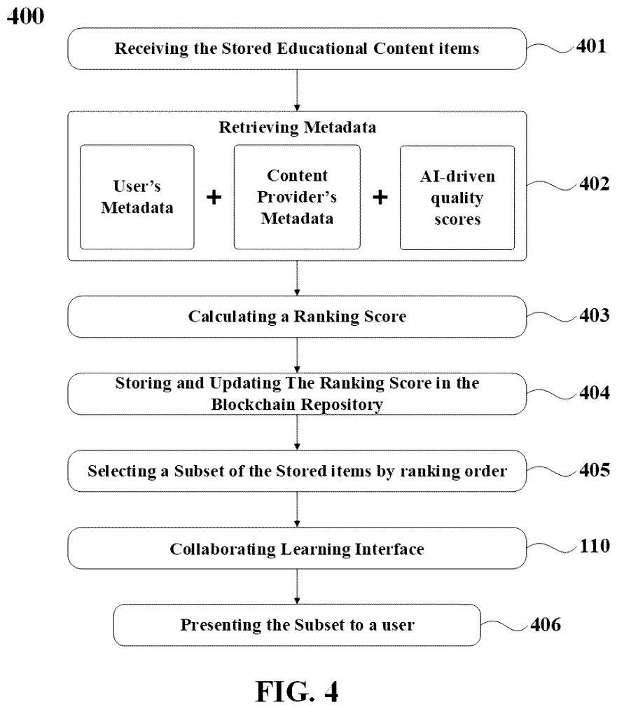

FIG. 4 illustrates a process diagram showing the AI-driven quality score methodology employed by the AI module in the system of FIG. 1, according to one embodiment herein.

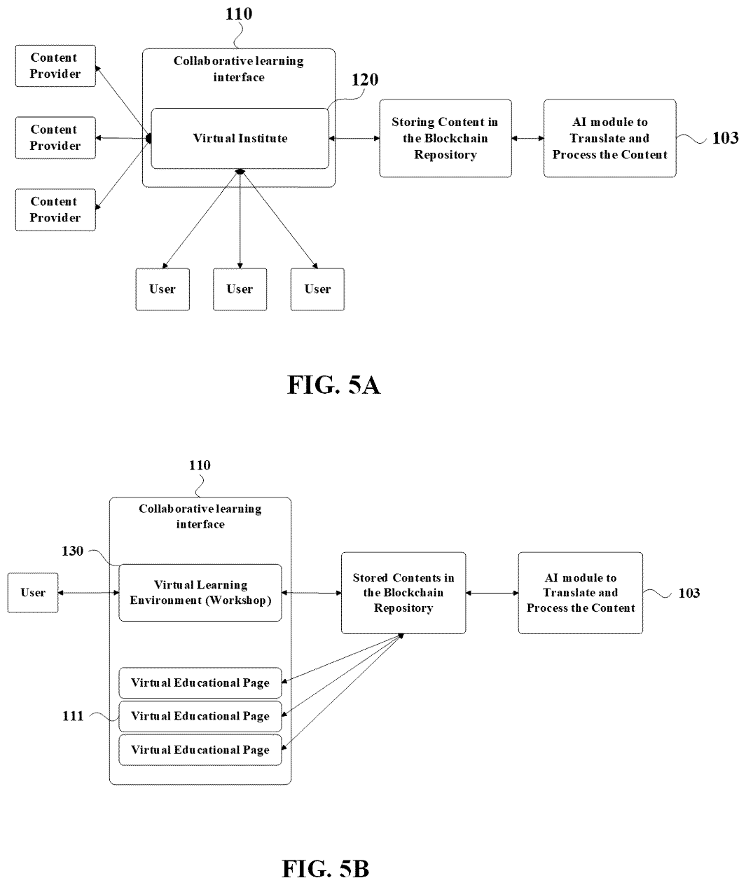

FIG. 5A illustrates a block diagram depicting a virtual institute of customizable educational interface, according to one embodiment herein.

FIG. 5B illustrates a block diagram depicting a virtual learning environment of customizable educational interface, according to one embodiment herein.

### DETAILED DESCRIPTION

In the following detailed description, reference is made to the accompanying drawings, which form a part hereof, and are shown by way of illustration embodiments in which the disclosure may be practiced. It is to be understood that other embodiments may be utilized and logical, mechanical and other changes may be made without departing from the spirit and scope of the present disclosure. The following detailed description is, therefore, not to be taken in a limiting sense. In addition, throughout the specification, the meaning of “a”, “an”, and “the” include plural references. The meaning of “in” includes “in” and “on”.

As used herein, the terms “customer”, “user”, “subscriber”, and “follower” may be used interchangeably to refer to an entity that has or is predicted to in the future make a procurement of a product, service, content, and/or application from another entity. As such, users include not just an individual or a family, but also businesses, organizations, or the like.

As used herein, the terms “content provider”, “educator”, “educational organization” and “provider” may be used interchangeably to refer to a provider of any network-based content item, product, service, and/or application.

It is to be understood that any descriptions in this specification that utilize phrases such as ‘an embodiment’, ‘one embodiment’, or ‘an example embodiment’ are intended to indicate that the corresponding embodiment may, but not necessarily will, incorporate a particular feature, structure, or characteristic. Furthermore, the use of such phrases does not imply that they are referencing a single, specific embodiment. Additionally, it is well within the capabilities of one of ordinary skill in the art to adapt and apply any disclosed feature, structure, or characteristic to other embodiments, whether or not they are explicitly described herein.

The following section provides a concise introduction to the core innovations, offering a foundational understanding of the system's key aspects. This brief overview is not meant to be exhaustive, nor is it intended to highlight essential elements or limit the scope of the invention. Instead, its purpose is to introduce simplified concepts that will be further elaborated upon in the more detailed description that is presented later.

Briefly stated, the various embodiments herein provide a system 100 configured to support an online social network platform according to one implementation. The system 100 may include multiple modules which may operate over the network on the server side. In the preferred embodiment, the system 100 consists of six components: i) a blockchain content repository 101, for storing educational content items and metadata; ii) a data collector module 102 for collecting metadata from user interactions and content provider ratings; iii) an AI module 103 for performing various machine learning and artificial intelligence-based methods to enhance the provided content items and learning experience of users; iv) a recommendation module 104 to generate personalized suggestions for users; v) a certificate issuance module 105 to issue digital certificates to users upon completion of all educational content items in a course; vi) a collaborative learning interface 110 designed for users and educators to access and interact within the system. A more detailed description of each component of the system is presented below.

The system 100 may be accessible across a plurality of devices, including but not limited to, mobile phones, tablets, web browsers, various operating systems, virtual reality (VR) headsets, and smart TVs. The computing device may be used by either a user or an educator, wherein the user may access the online social network platform via the collaborating learning interface 110 and receive educational content items according to the online course. The data collector module 102 may also extract user interactions with the provided content, and transmit and store them in the blockchain repository, thereby enabling the tracking and verification of user engagement and progress.

In the preferred embodiment, the data collector module 102 may include an extracting engine configured to gather and process data and metadata of users and content providers from various interactions within the communication management system 100. The module 102 may interact with other system components, such as the collaborative learning interface 110, the AI Module 103, and the recommendation module 104, to facilitate comprehensive data management and enable the system to provide personalized learning experiences.

The extracting engine within the data collector module 103 may be responsible for capturing and analyzing data and metadata from user and content provider interactions. This engine may extract various types of data, including but not limited to user engagement metrics, content quality indicators, user preferences, and provided content items and may transmit this data to the blockchain repository 101 for secure storage and further processing.

The extracting engine may interact with users through their activity on the virtual personal page 112, monitoring user activities including, but not limited to, time spent on different educational content items, frequency of interactions, and participating in collaborative learning activities. In one embodiment, the extracting engine may receive user feedback and ratings of educational content through a rating interface section embedded in each virtual educational page 111. In another embodiment, users' preferences including preferred content formats, topics of interest, and learning styles may be gathered by the extracting engine to enhance personalized recommendations and content delivery.

The interaction of the extracting engine within the data collector module 102, with content providers may be through the educational page 111. In one embodiment, when content providers submit educational content, the extracting engine may extract relevant metadata in addition to the content items, such as content type, subject, target audience, and content quality scores derived from AI module 103. While receiving feedback from users and collecting them using the extracting engine, content providers may use this information in order to improve their contents and maintain high-quality content standards.

In one embodiment, the extracting engine may periodically perform data integrity checks to ensure the accuracy and consistency of the metadata stored in the blockchain repository 101. These checks may involve verifying that the metadata collected from user and content provider interactions matches the data stored in the blockchain, ensuring the reliability of the system.

The data collector module 102 may communicate with the blockchain repository 101, ensuring secure and immutable storage of metadata. The extracting engine may package and encrypt collected metadata from users and content providers and transmit it to the blockchain repository 101. The blockchain repository 101 securely stores this data in a decentralized manner, making it available to other modules of the system 100.

In the preferred embodiment, the blockchain repository 101 serves as a secure and immutable storage solution for all metadata and educational content within the communication management system 100. The blockchain repository 101 may interact with various system components, including the data collector module 102, the AI module 103, the recommendation module 104, and the certificate issuance module 105, to ensure the integrity, transparency, and security of stored data.

In an example embodiment, the blockchain repository 101 may also provide a digital copyright protection mechanism, ensuring that educational content is protected from unauthorized use, copying, and distribution. The blockchain module can create a decentralized and immutable record of content ownership, tracking transactions and usage of educational content. This allows content creators and owners to maintain control over their intellectual property, while also providing a transparent and secure way to share and access educational content. By leveraging blockchain technology, the system can provide a robust digital copyright protection mechanism, ensuring that educational content is protected and creators are fairly compensated for their work.

In an alternative embodiment, the system's repository 101 may incorporate a cloud-based storage solution, utilizing a scalable and flexible infrastructure to store and manage educational content. This approach may be preferred in scenarios where high availability, low latency, and rapid scalability are critical.

The blockchain repository 101 may receive metadata from the data collector module 102. This metadata, which may include user engagement metrics, content quality indicators, and user preferences, may be transmitted to the blockchain repository 101 in an encrypted format to ensure data privacy and security. The blockchain's decentralized nature ensures that once the metadata is recorded, it cannot be altered or tampered with, thereby providing a trustworthy and auditable record of all interactions within the system.

The AI module 103 may utilize the data stored in the blockchain repository 101 to enhance its analytical capabilities. In one embodiment, the AI module 103 may access content items and content quality metrics to refine its machine learning algorithms, improving the accuracy of translations, content generation, and quality assessments. The immutable nature of the blockchain ensures that the data used by the AI module 103 is reliable and consistent, which is crucial for maintaining the integrity of AI-driven processes.

The recommendation module 104 may leverage the blockchain repository 101 to provide personalized content suggestions to users. In one embodiment, by accessing user preferences, engagement history, and content quality scores stored on the blockchain, the recommendation module 104 may generate accurate and relevant recommendations. The blockchain may ensure that these recommendations are based on verified data, enhancing the trustworthiness of the recommendations provided to users.

In one embodiment, the blockchain repository 101 may support data versioning and rollback features. This allows the system to maintain historical versions of metadata and educational content, providing a means to revert to previous states if necessary. This version control enhances the robustness of the data management process and ensures that the system can recover from errors or unauthorized changes.

The blockchain repository 101 may also facilitate secure e-commerce transactions through its integration with the payment gateway module. When users purchase educational content or services, transaction details may be recorded on the blockchain, ensuring that all financial interactions are transparent and secure. The blockchain's ability to provide a permanent and unalterable record of transactions helps prevent fraud and ensures that all parties can trust the integrity of the financial data.

In another embodiment, the system 100 may comprise a decentralized, blockchain-based cryptocurrency that is native to the system, wherein said cryptocurrency of the system may be implemented using a proof-of-stake consensus algorithm, thereby ensuring that the currency remains scarce and valuable over time. Furthermore, the cryptocurrency may be specifically designed to support the education sector, with built-in features that enable secure, transparent, and tamper-proof transactions. Additionally, the system cryptocurrency may be configured to facilitate seamless transactions within the system, providing users a means of accessing premium educational content and other value-aided services.

In the preferred embodiment, the system may enable users to earn its cryptocurrency in various ways within the system, including at least one of completing online courses, participating in educational activities, and inviting friends to join the platform. Additionally, the system, may gift a certain amount of its cryptocurrency to new users upon joining the social network platform, thereby providing an incentive to explore the platform. In another embodiment, the cryptocurrency of the system is fully integrated with the payment gateway module, thereby ensuring a secure transaction experience for users.

In the preferred embodiment, the Artificial Intelligence (AI) module 103 is a central component of the communication management system 100, leveraging advanced machine learning and artificial intelligence techniques to enhance various system functionalities. The AI module 103, may interact with several other system components, including the data collector module 102, the blockchain Repository 101, the recommendation module 104, and the certificate issuance module 105, to provide a personalized and intelligent educational experience.

The module 103 may be configured to perform a plurality of AI-driven tasks, including, but not limited to, machine translation, content generation, and quality assessment. By leveraging machine learning models, neural networks, and natural language processing techniques, the AI module 103 may analyze and process large volumes of data to deliver accurate and relevant results.

In an alternative embodiment, the AI module 103 may utilize a subscription-based service that provides access to a library of available artificial intelligence models according to one implementation. This subscription service may be employed to perform one or more of the AI-driven tasks, including, for example, machine translation, content generation, and quality assessments.

In another embodiment, one of the primary functions of the AI module 103 may be to perform machine translation on the educational content stored in the blockchain repository 101 over the network, as in FIG. 2. In one embodiment, the module may use a neural network-based translation model, which may be a transformer architecture trained in a large multilingual corpus and optimized for translation accuracy, or a subscription-based AI language model over the network. The neural network-based translation model may be further optimized through training on the stored data in the blockchain repository 101 according to one implementation.

According to one implementation, generation of printable pamphlets from a plurality of stored content items of a provided course in the blockchain repository 101 may involve the execution of a document generation algorithm integrated with the Artificial Intelligence (AI) module 103 on the server side. This algorithm, is trained on a dataset of educational content items and optimized to recognize patterns and relationships therein. Subsequently, the trained algorithm utilizes predefined templates and layout rules to produce formatted documents, thereby generating a printable pamphlet from the plurality of stored content items. In an alternative embodiment, a subscription-based document generation model may be utilized to generate printable pamphlets from a plurality of stored content items of a course provided by a content provider over the network.

The AI module 103 may also be involved in generating new images and videos based on the stored educational content items according to one implementation. In one embodiment, this may be achieved using a Generative Adversarial Network (GAN), which may be pre-trained on a dataset of educational multimedia content, or a subscription-based GAN model over the network. In the preferred embodiment, the GAN may generate contextually relevant visuals over the network, enhancing the overall learning experience. The processing of these generated visuals is executed on a cloud infrastructure, ensuring scalability and efficiency. The new generated images and/or videos may also be stored in the blockchain repository for further utilization from the user according to one implementation.

Furthermore, the AI module 103 may use a natural language processing technique to create assessments and generate question and answer sets from the stored content items of a course. In the preferred embodiment, the NLP technique may be conducted using semantic analysis, which involves analyzing the meaning of words and phrases in context, and concept extraction, which involves identifying key concepts and relationships within the content. In one example embodiment, the system 100 may enable oral assessments wherein the AI module 103 may convert audio content to text and evaluate the converted text related to the course content to determine a passing grade. For instance, a user may participate in an oral exam, and the AI module 103 may convert the user's spoken responses into text. The AI module 103 may then compare the converted text to the course content to determine whether the user has met the degree requirements or is eligible to unlock the next training sessions. Additionally, the system may allow users to create their own questionnaires to test their understanding of the subject, thereby providing a more personalized and interactive learning experience, enabling users to take a more active role in their learning process.

In the preferred embodiment, the AI module 103 may integral to the content quality evaluation process 300. The AI module 103 may utilize a machine learning-based evaluation framework to ascertain a quality score 304 for each educational content item provided by educators. The quality evaluation process 300, as depicted in FIG. 3, may be implemented according to one embodiment. This framework may extract various features 301 from the content, including, but not limited, to semantic meaning, readability metrics, engagement metrics, relevance to a specific topic or domain, accuracy of information, completeness of information, consistency of information, and tone and sentiment of the content. The AI module 103 may assign evaluation scores 302 to these features. Subsequently, the AI module 103 may calculate a weighted sum 303 of these features to generate a quality score 304. Consequently, to ensure equitable comparison and ranking of content items, the evaluation framework normalizes the quality scores across different content items to generate an AI-driven quality score. This normalization step 305 may enable the comparison of quality scores across various content items, which may affect ranking and selecting the best content.

Referring to FIG. 3, different extracted features 301 may have varying value ranges. For example, readability metrics may range from 0 to 100, while engagement metrics may range 0 to 1. Without weighted sum, features with larger value ranges could dominate the quality score calculation, resulting in biased outcomes.

Additionally, different content items in the blockchain repository 101 may exhibit diverse characteristics, such as text length, format, or style, which could impact the feature extraction process 300. For example, a long, comprehensive article may have a higher readability score compared to a short, concise blog post, solely due to its length. Normalization 305 may account for these variations, ensuring that quality scores remain comparable across a wide range of content items.

According to one implementation, the collaborative learning interface 110 may display a visual representation of the AI-driven quality score for each educator-provided content item within an embedded section of the virtual educational page 111, thereby facilitating informed decision-making and enabling educators to identify high-quality content that meets specific learning objectives.

Referring to FIG. 2, the content of the virtual educational page 111 in a first language may be initially stored in the blockchain repository 101 according to one implementation. Subsequently, the AI module 103 may process stored content of a course, generating a processed content 201 that includes one or more combinations of the following: pamphlets, images, videos, and assessments, which may be translated into a desired language of the user. In one embodiment, the processed content 201 may be translated into multiple languages, such as a second language and a third language, once, and stored in the blockchain repository 101. The translated content in the second language 201 may then be presented in the collaborating learning interface 110, to followers of the course who prefer the second language, thereby facilitating language-specific access to the course materials. In another embodiment, the translation may be in the form of subtitles, dubbing with the voice of the person providing it, or personalization of the voice with a voice of the user's choice for video and audio content.

In relation to the data collector module 102, the AI module 103 may utilize the metadata gathered from user and content provider interactions to refine its algorithms and models according to one implementation. In the preferred implementation, The AI module 103 continuously learns from this data, adapting its outputs to better meet the needs and preferences of users.

The AI module 103 may interact with the recommendation module 104 to provide personalized content suggestions. In one embodiment, by analyzing user preferences, engagement history, and content quality scores stored in the blockchain repository 101, the recommendation module 104 may generate accurate and relevant recommendations. These recommendations are based on a comprehensive understanding of user behavior and content characteristics, ensuring a personalized learning experience.

In the preferred embodiment, the recommendation module 104 may operate by executing a series of computer implemented steps to analyze and rank the stored educational content items in the blockchain repository 101, ultimately presenting the most relevant subset to the users via the collaborative learning interface 110.

Referring to FIG. 4, initially, the recommendation module 104 receives a plurality of stored educational content items from the blockchain repository 101 at step 401. This step involves accessing the content items, which may include various forms of educational materials such as text documents, images, and videos. Each content item stored in the blockchain repository is associated with corresponding metadata that the data collector module 102 provided.

At step 402, the recommendation module 104 may retrieve the extracted metadata associated with each received content item. This metadata may include user-related information, content provider-related information, AI-driven quality scores (assessed by the AI module 103 as described). The combination of these metadata types may provide a comprehensive understanding of each content item's relevance and quality.

In step 403, the recommendation module 104 may calculate a ranking score for each received content item based on the retrieved metadata. According to one implementation, the ranking score is determined by applying a weighted combination of the various metadata elements, which ensures that the most relevant and high-quality content is prioritized. For example, a content item with high user engagement metrics, positive user feedback, and a high AI-driven quality score would receive a higher ranking score compared to other items.

Once the ranking scores are calculated in step 403, they may be stored and continuously updated in the blockchain repository 101 at step 404. This step ensures that the ranking information is securely maintained and remains up-to-date, reflecting any changes in user interactions, content updates, or quality assessments.

Following the storage and updating of the ranking scores, the recommendation module 104 may select a subset of the stored content items at step 405. In the preferred embodiment, this subset may be chosen based on the ranking scores, with the highest-ranked items being prioritized for recommendation. The selection process ensures that users receive the most relevant and valuable content tailored to their learning needs and preferences.

At step 406, the collaborative learning interface 110 may display the selected subset to the user in an integrated manner, such as by embedding the recommendations within the search results page, where the search query is executed through a search bar embedded in the interface 110, or by presenting the recommendations as a sidebar or inline suggestion while the user is viewing educational content on an educational page 111, thereby providing a personalized and contextually relevant learning experience.

In the preferred embodiment, the certificate issuance module 105 of the communication management system 100, may be responsible for issuing digital certificates 106 to users upon completion of all educational content items in a course. This module operates over the network and integrates with various other system components, ensuring that the certification process is seamless, secure, and reliable.

The certificate issuance module 105 may perform a series of computer-implemented steps to generate and issue certificates 106. Upon detecting that a user has completed all the required process. In one embodiment, this process involves verifying the completion status of the user through interactions with the blockchain repository 101, wherein the user's progress and achievements are securely stored.

The module 105 may integrate with a digital signature system to provide verifiable and tamper-proof certificates using public-key cryptography according to one implementation. This integration may ensure that each issued certificate is uniquely signed with a private key, which may be verified using the corresponding public key. The use of public-key cryptography guarantees that the certificate 106 may be secure and cannot be altered or forged.

The collaborative learning interface 110 may be configured to let users and content providers to access to different modules of social network platform of the system 100 over the network according to one implementation. This interface supports various functionalities that enhance learning, communication and collaboration among users.

Referring to FIG. 1, the collaborative learning interface 110 may comprise a virtual educational page 111 associated with content providers, such as universities, educational organizations, and educators, and a virtual personal page 112 associated with users, in the preferred embodiment. According to one implementation, the virtual educational page 111 and/or the virtual personal page 112 of the learning interface 100 may organize and display the stored files of each course or page in a structured and easily navigable manner, using distinct format sections. In one example embodiment, a “Document” section for displaying document files, a “Videos” section for displaying video formatted files, and a “Resources” section for displaying additional learning content materials may be configured to both personal and education pages. In another embodiment, the educational page 111 may provide announcements and notifications of the content provider's activities, including, but not limited to: uploading new educational content items in a course, commenting on discussions in the chatroom, scheduling upcoming live sessions, and sending reminders about assignment deadlines, thereby facilitating engagement and collaboration between content providers and users.

Furthermore, the collaborative learning interface 110 may be configured to support a real-time chat room feature. In one embodiment, this chat room allows multiple users to communicate simultaneously, providing an interactive platform for discussion and collaboration. The machine translation module integrated within the AI module 103 may translate chat messages in real-time into the language selected by the user. This feature may ensure that users can engage in meaningful conversations regardless of language barriers. The chat room may be configured as private or public, supporting various communication needs and preferences.

Additionally, the chat room within the collaborative learning interface 110 may support multimedia communication, allowing users to share text, images, videos, and other multimedia content. This functionality may enrich the learning experience by enabling users to present and discuss educational materials in diverse formats. Additionally, the chat room may employ encryption techniques to ensure secure communication between users, protecting the confidentiality and integrity of the shared information.

In one example embodiment, the collaborative learning interface 110 may further incorporate a virtual input module, comprising a virtual keyboard and whiteboard, thereby enabling users and content providers to generate and manipulate graphical and textual content in a digital environment. The AI module 103 may subsequently employ optical character recognition (OCR) and natural language processing (NLP) techniques to convert the written content into a machine-readable format, such as a printable file, which can be further edited, sorted, and printed in a computer-typed format, or transmitted to other users. This feature facilitates interactive and collaborative learning activities, such as real-time brainstorming sessions, group projects, and discussions, and enables the creation and sharing of educational content in a more dynamic and engaging manner.

In the preferred embodiment, the collaborative learning interface 110 may offer a customizable educational interface. Referring to FIG. 5A, the interface may enable content providers to establish a virtual institute 120 cooperatively with each other. Content providers may collaborate to create comprehensive educational programs, combining their expertise and resources to deliver high-quality educational content. This cooperative approach fosters a collaborative educational environment, benefiting both content providers and users. Additionally, this may create a competitive atmosphere in the educational environment, where content providers may be motivated to provide better content that may suit users' needs. For example, several educators can form a community of courses such as math, physics, history, astronomy, and lifestyle to form a virtual institute.

In the preferred embodiment, users may also create virtual learning environments 130, such as workshops, by selecting a group of content providers through the collaborative learning interface 110 referring to FIG. 5B. This feature allows users to tailor their learning experiences by choosing content providers that align with their educational goals and preferences. Users can design personalized workshops 130, bringing together diverse perspectives and expertise to enhance their learning.

The collaborative learning interface 110 may be equipped with a search module, allowing users to search for educational content and recommendations according to one implementation. The interface may utilize a weighted indexing scheme and a natural language processing technique to optimize the search query interpretation and result retrieval.

A follow button widget may be embedded in the virtual educational page 111, said widget being a graphical user interface element according to one implementation. In the preferred implementation, a server-side linking mechanism associated with the follow button widget may be implemented. The linking mechanism a virtual personal page 112 with a virtual educational page 111 upon activation of the follow button widget by a user.

According to the preferred implementation, a payment gateway module 107 may be configured to the social network platform of the system 100. The payment module 107 may comprise two subcomponents including, (a) a secure payment processing, (b) a content entitlement system, each responsible for specific functionalities that facilitate secure and user-friendly transactions.

The secure payment processing engine of the payment module 107 may be responsible for handling user transactions using a plurality of payment methods, including credit cards, debit cards, bank transfers, digital wallets, and the system-specific cryptocurrency. The secure payment processing engine may employ advanced encryption and security protocols to protect user financial information and prevent unauthorized access or fraud.

The content entitlement system of the payment module 107 may manage user access to purchased content. Upon successful payment, this system may grant users access to the selected educational content items, ensuring that only authorized users can view or interact with the content. The content entitlement system is synchronized with the blockchain repository 101 to maintain a verifiable and tamper-proof record of content access rights.

A user profile manager widget embedded in the virtual personal page 112 of each user may be configured to update the virtual personal page 112 with the purchased content according to one implementation. This manger widget may ensure the user to easily locate and access their acquired educational content. Additionally, the user profile manager may have access to the API of payment module 107 to track the payment history of each user, displaying a detailed record of all transactions for reference and auditing purposes.

In one embodiment, the notification module of the collaborating learning interface 110 may inform users of their transaction statuses and content access. The module may send real-time notifications via SMS, or in-platform messages, ensuring that users may be promptly updated on the progress and outcome of their transactions. Notifications of payment may include payment confirmation, content access granted, transaction failures, and other relevant updates.

In another embodiment, the payment gateway module 107 may support the use of the system-specific cryptocurrency, which provides an additional layer of security and convenience for transactions within the platform. Users can purchase the cryptocurrency using traditional payment methods and then use it to pay for educational content and services. This approach ensures faster transaction processing times and reduces dependency on external financial institutions.

The payment gateway module 107 may also include a robust detection and prevention mechanism according to one implementation. By analyzing transaction patterns and employing machine learning algorithms, the system 100 may identify and flag suspicious activities, protecting users and the platform from potential threats.

Various embodiments and aspects of the invention have been described, but those skilled in the art will recognize that other embodiments and aspects exist. The embodiments and aspects presented are illustrative and not exhaustive, with the full scope and essence of the invention defined by the claims that follow.

What is claimed is:

1. A communication management system, comprising:
(a) a processor; and
(b) a non-transitory computer-readable medium comprising a plurality of executable instructions, wherein the plurality of executable instructions, after executing, cause the communication management system to:
i. store a plurality of educational content items provided by users and content providers, in a secure content repository on a blockchain system, wherein the storage and retrieval of content items are conducted over a network;
ii. perform machine translation on the plurality of stored content items using a neural network-based translation model, wherein the translation model is a transformer architecture trained on a large multilingual corpus and optimized for translation accuracy, and the translation process is executed on a server-side of the network;
iii. generate a printable pamphlet from the plurality of stored content items by executing a document generation algorithm, wherein the algorithm uses predefined templates and layout rules, implemented on the server-side, to produce formatted documents;
iv. generate new images and/or videos based on the plurality of stored content items by using a generative adversarial network (GAN) on the server side of the network, wherein the GAN is pre-trained on a dataset of educational multimedia content to generate contextually relevant visuals, with processing executed on a cloud infrastructure;
v. create assessments from the plurality of stored content items by using a natural language processing (NLP) technique, including semantic analysis and concept extraction, to generate a plurality of question and answer sets, evaluated and refined by a machine learning model for accuracy and relevance;
vi. determine a quality score for each of the plurality of stored content items using a machine learning-based evaluation framework on the server side over the network, wherein the framework:
1. extracts a plurality of features from each of the plurality of stored educational content items, including at least one of following metrics: semantic meanings, readability metrics, engagement metrics, relevance to a specific topic or domain, accuracy of information, completeness of information, consistency of information, and tone and sentiment of the content;
2. assigns an evaluation score for each of the plurality of features;
3. calculates a weighted sum over the assigned evaluation scores to generate a quality score;
4. normalizes the quality scores across different content items to create an AI-driven quality score;
vii. issue digital certificates, over the network, for users upon completion of all the educational content items in a course, using a certificate issuance module on the server side;
viii. provide personalized recommendations to users utilizing a recommendation module on the server side, based on the plurality of stored content items in the blockchain repository;
ix. facilitate secure e-commerce transactions through an integrated payment gateway over the network;
x. enable interactive learning experiences via a collaborative learning interface over the network for users and content providers.

2. The communication management system according to claim 1, wherein the system is accessible across a plurality of computing devices, providing a consistent user experience through different devices and platforms.

3. The communication management system according to claim 1, further comprising a data collector module configured with an extracting engine, wherein the engine extracts metadata from the learning interface, wherein the extracted metadata includes at least one of: users' interactions, content provider ratings and reviews, and AI-driven quality scores; and transmits the extracted metadata to the blockchain repository.

4. The communication management system according to claim 1, wherein the recommendation module executes a computer-implemented method, the method comprising the steps of:
(a) receiving a plurality of the plurality of stored educational content items in the blockchain repository;
(b) retrieving the extracted metadata from each of the plurality of received content items;
(c) calculating a ranking score for each of the plurality of received content items based on the retrieved metadata, wherein the ranking score is a weighted combination of the retrieved metadata;
(d) storing and updating the ranking scores for each of the received content items in the blockchain repository; and
(e) selecting and presenting a subset of the received content items to generate a personalized recommendation, wherein the selected subset is ordered by ranking scores of them.

5. The communication management system according to claim 1, wherein the collaborative learning interface comprises a virtual educational page and a virtual personal page, allowing users to organize and manage their learning activities and progress.

6. The communication management system according to claim 1, wherein the collaborative learning interface comprises:
(a) a follow button widget embedded in the virtual educational page, said widget being a graphical user interface element;
(b) a server-side linking mechanism, wherein the linking mechanism associates the virtual personal page with the virtual educational page upon activation of the follow button widget by a user;
(c) a notification module, wherein the module enables the user to receive updates and notifications related to the virtual educational page, said updates and notifications being transmitted over a network.
(d) a search module configured to allow users to find educational pages within the blockchain repository, wherein the search module employs the recommendation module and a machine learning-based search algorithm to provide search results, utilizing a weighted indexing scheme and natural language processing techniques to optimize search query interpretation and result retrieval.

7. The communication management system according to claim 1, wherein the collaborative learning interface further comprises a real-time chat room allowing multiple users to communicate simultaneously, with the machine translation module translating the chat in real-time into a language selected by the user, wherein the chat room can be configured as private or public, supports multimedia communication, and employs encryption techniques to ensure secure communication between users.

8. The communication management system according to claim 1, wherein the collaborative learning interface is further comprising a customizable educational interface capable of:
(a) enabling content providers to establish virtual institutes cooperatively with each other; and
(b) permitting users to create virtual learning environments, such as workshops, by selecting a group of content providers.

9. The communication management system according to claim 1, wherein the certificate issuance module integrates with a digital signature system to provide verifiable and tamper-proof certificates using public-key cryptography, and wherein the certificates are stored in the blockchain for verification.

10. The communication management system according to claim 1, wherein the payment gateway module comprising:
(a) a secure payment processing engine for handling user transactions for a plurality of payment methods;
(b) a content entitlement system, granting access to selected content upon successful payment.
